(19) United States
(12) Patent Application Publication
(10) Pub. No.: US 2026/0296506 A1
(43) Pub. Date: Oct. 1, 2026

(54) VEHICLE CONTROL DEVICE, VEHICLE CONTROL METHOD, AND NON-TRANSITORY STORAGE MEDIUM

(71) Applicant: HONDA MOTOR CO., LTD., Tokyo (JP)

(72) Inventors: Yuma Watanabe, Tokyo (JP); Hiroki Sagami, Tokyo (JP); Toru Kokaki, Tokyo (JP)

(21) Appl. No.: 19/551,644

(22) Filed: Feb. 27, 2026

(30) Foreign Application Priority Data
Mar. 26, 2025 (JP) 2025-051442

(51) Int. Cl. B60W 60/00; B60W 50/08

(52) U.S. Cl. CPC B60W 60/0059; B60W 50/082; B60W 60/0053; B60W 2540/18

(57) ABSTRACT

A vehicle control device includes: a detector detecting a vehicle operation which is a driver's operation associated with traveling of a vehicle; a controller performing vehicle control which is automated driving or driving support of the vehicle; and an acquirer acquiring a release instruction associated with release of the vehicle control according to the driver's operation on a release operator. The controller performs: determining whether a type of the vehicle control and a type of the vehicle operation match; releasing the vehicle control when the release instruction is acquired and it is determined that the type of the vehicle control and the type of the vehicle operation match; and continuously performing the vehicle control when the release instruction is acquired and it is determined that the type of the vehicle control and the type of the vehicle operation do not match.

### CROSS-REFERENCE TO RELATED APPLICATION

Priority is claimed on Japanese Patent Application No. 2025-051442, filed Mar. 26, 2025, the content of which is incorporated herein by reference.

### BACKGROUND

### Field of the Invention

The present invention relates to a vehicle control device, a vehicle control method, and a non-transitory storage medium.

### Description of Related Art

Recently, countermeasures for providing access to a sustainable transportation system in which vulnerable persons out of traffic participants are considered have been actively studied. In order to realize such countermeasures, focus has been concentrated on research and development for further improving safety or convenience of traffic through research and development on driving support technology of supporting a driver's driving. For example, a traveling control device that can switch between traveling of a vehicle based on a driver's operation and traveling of the vehicle based on driving support is known (see Japanese Unexamined Patent Application, First Publication No. 2007-196714 and Japanese Unexamined Patent Application, First Publication No. 2019-119373).

### SUMMARY

In the traveling control device according to the related art, vehicle control may not be appropriately released. For example, driving support may not be appropriately released. More specifically, for example, when a driver of a vehicle does not have an intention of releasing vehicle control, driving support may be released.

The present invention was made in consideration of the aforementioned circumstances, and an objective thereof is to provide a vehicle control device, a vehicle control method, and a non-transitory storage medium that can appropriately release vehicle control. More specifically, an objective thereof is to release driving support when a driver of a vehicle has an intention of releasing vehicle control and to allow the vehicle to continuously perform appropriate behavior according to the driver's intention even after vehicle control has been released by releasing the driving support in consideration of the driver's operation state. Another objective thereof is to contribute to advancement of a sustainable transportation system.

A vehicle control device, a vehicle control method, and a non-transitory storage medium according to the present invention employ the following configurations.
(1) An vehicle control device according to an aspect of the present invention includes a storage medium configured to store computer-readable instructions; and one or more processors connected to the storage medium, wherein the one or more processors execute the computer-readable instructions to: detect a vehicle operation, the vehicle operation being a driver's operation associated with traveling of a vehicle; perform vehicle control on the basis of a surrounding environment of the vehicle, the vehicle control being automated driving or driving support of the vehicle; acquire a release instruction associated with release of the vehicle control according to the driver's operation on a release operator; determine whether a type of the vehicle control and a type of the vehicle operation match; release the vehicle control when the release instruction is acquired and it is determined that the type of the vehicle control and the type of the vehicle operation match; and continuously perform the vehicle control when the release instruction is acquired and it is determined that the type of the vehicle control and the type of the vehicle operation do not match.
(2) In the aspect of (1), the type of the vehicle control includes some or all of acceleration control associated with acceleration, deceleration control associated with deceleration, and stop control associated with stopping, and the type of the vehicle operation includes some or all of acceleration operation associated with the acceleration, deceleration operation associated with the deceleration, and stop operation associated with the stopping.
(3) In the aspect of (1) or (2), the one or more processors execute the computer-readable instructions to determine whether the type of the vehicle control matches the acceleration operation satisfying a first condition when a degree of the acceleration operation satisfies the first condition.
(4) In the aspect of (1) or (2), the one or more processors execute the computer-readable instructions to determine whether the type of the vehicle control matches the deceleration operation satisfying a second condition when a degree of the deceleration operation satisfies the second condition.
(5) In the aspect of any one of (1) to (3), the one or more processors execute the computer-readable instructions to release the acceleration control when it is determined that the type of the vehicle control and the type of the vehicle operation match as the acceleration operation is detected while performing the acceleration control and when the release instruction is acquired.
(6) In the aspect of any one of (1) to (4), the one or more processors execute the computer-readable instructions to release the deceleration control when it is determined that the type of the vehicle control and the type of the vehicle operation match as the deceleration operation is detected while performing the deceleration control, and when the release instruction is acquired.
(7) In the aspect of any one of (1) to (6), the one or more processors execute the computer-readable instructions to release the stop control when it is determined that the type of the vehicle control and the type of the vehicle operation match as the stop operation is detected while performing the stop control, and when the release instruction is acquired.
(8) In the aspect of (1) or (2), the one or more processors execute the computer-readable instructions to: detect whether a steering operation is being performed, the steering operation being the driver's steering operation; and release the acceleration control or the deceleration control, both of the acceleration control or the deceleration control and the steering control, or all of the acceleration control, the deceleration control, and the steering control regardless of whether the release instruction has been acquired when the steering control included in the vehicle control is being performed, the steering operation is detected, and it is determined that the acceleration control or the deceleration control included in the vehicle control matches the type of the vehicle operation.
(9) In the aspect of (1) or (2), the one or more processors execute the computer-readable instructions to release the stop control when the acceleration operation is detected while performing the stop control.
(10) In the aspect of (1) or (2), the one or more processors execute the computer-readable instructions to: detect a degree of the driver's steering operation; determine whether a difference between the degree of the steering operation and a degree of a steering operation based on the steering control is equal to or greater than a threshold value when the vehicle is traveling on a road requiring right turn or left turn and steering control of the vehicle is being performed; and release the vehicle control when the difference between the degree of steering operation and the degree of steering control is equal to or greater than the threshold value.
(11) According to another aspect of the present invention, there is provided a vehicle control method that is performed by a computer, the vehicle control method including: detecting a vehicle operation, the vehicle operation being a driver's operation associated with traveling of a vehicle; performing vehicle control on the basis of a surrounding environment of the vehicle, the vehicle control being automated driving or driving support of the vehicle; acquiring a release instruction associated with release of the vehicle control according to the driver's operation on a release operator; determining whether a type of the vehicle control and a type of the vehicle operation match; releasing the vehicle control when the release instruction is acquired and it is determined that the type of the vehicle control and the type of the vehicle operation match; and continuously performing the vehicle control when the release instruction is acquired and it is determined that the type of the vehicle control and the type of the vehicle operation do not match.
(12) According to another aspect of the present invention, there is provided a non-transitory storage medium storing a program causing a computer perform: detecting a vehicle operation, the vehicle operation being a driver's operation associated with traveling of a vehicle; performing vehicle control on the basis of a surrounding environment of the vehicle, the vehicle control being automated driving or driving support of the vehicle; acquiring a release instruction associated with release of the vehicle control according to the driver's operation on a release operator; determining whether a type of the vehicle control and a type of the vehicle operation match; releasing the vehicle control when the release instruction is acquired and it is determined that the type of the vehicle control and the type of the vehicle operation match; and continuously performing the vehicle control when the release instruction is acquired and it is determined that the type of the vehicle control and the type of the vehicle operation do not match.

With the vehicle control device, the vehicle control method, and the non-transitory storage medium according to the aspects of (1) to (12), it is possible to appropriately release vehicle control by determining whether to release vehicle control on the basis of a driver's operation state. For example, since the driver performs the same operation as in vehicle control before the vehicle control has been released even after the vehicle control has been released, it is possible to allow the vehicle to maintain stable behavior even after the vehicle control has been released.

According to the aspect of (2), it is possible to release vehicle control when the driver's vehicle operating state is appropriate and the driver has an intention of releasing the vehicle control by releasing the vehicle control in response to acquisition of a release instruction when the vehicle is performing a behavior associated with acceleration, deceleration, or stopping and the type of vehicle control and the type of vehicle operation match.

According to the aspect of (3) or (4), it is possible to release vehicle control when the driver has an intention of releasing the vehicle control by determining whether the type of vehicle control and the type of vehicle operation match and releasing the vehicle control when the degree of acceleration operation or deceleration operation satisfies the conditions.

According to the aspects of (5) to (7), it is possible to release vehicle control when the vehicle M is predicted to continuously perform appropriate behavior even after the vehicle control has been released.

According to the aspect of (8), it is possible to release vehicle control without damaging convenience to the driver when the driver has an intention of releasing the vehicle control by releasing the vehicle control when steering control and vehicle control other than steering control are being performed, it is determined that the type of vehicle control other than steering control and the type of vehicle operation match, and a steering operation is performed by the driver.

According to the aspect of (9), it is possible to perform appropriate start of the vehicle M according to the driver's intention by releasing stop control when the driver's acceleration operation is detected while performing the stop control.

According to the aspect of (10), it is possible to perform appropriate control of the vehicle M according to the driver's intention by releasing vehicle control when the vehicle is traveling on a road requiring right turn or left turn, a steering operation is detected while performing steering control, and a difference between the degree of steering operation and a degree of steering operation based on the steering control is equal to or greater than a threshold value.

### BRIEF DESCRIPTION OF THE DRAWINGS

FIG. 1 is a diagram showing a configuration of a vehicle system employing a vehicle control system according to an embodiment.

FIG. 2 is a diagram showing an example of a correlation between a type of vehicle control and a type of vehicle operation when both types match.

FIG. 3 is a diagram showing a comparative example.

FIG. 4 is a diagram showing an example of a situation in which stop control is released according to the embodiment.

FIG. 5 is a flowchart showing an example of a process flow that is performed by a driving support device.

FIG. 6 is a diagram showing an example of a situation in which acceleration control is released according to the embodiment.

FIG. 7 is a diagram showing conditions in which vehicle control is released when steering control, acceleration control, or deceleration control is being performed.

FIG. 8 is a flowchart showing an example of a process flow that is performed by the driving support device.

FIG. 9 is a diagram showing an example of a situation in which stop control is released by an acceleration operation according to the embodiment.

FIG. 10 is a diagram showing an example of a situation in which steering control is released according to the embodiment.

FIG. 11 is a flowchart showing an example of a process flow that is performed by the driving support device.

### DETAILED DESCRIPTION OF THE INVENTION

### Entire Configuration

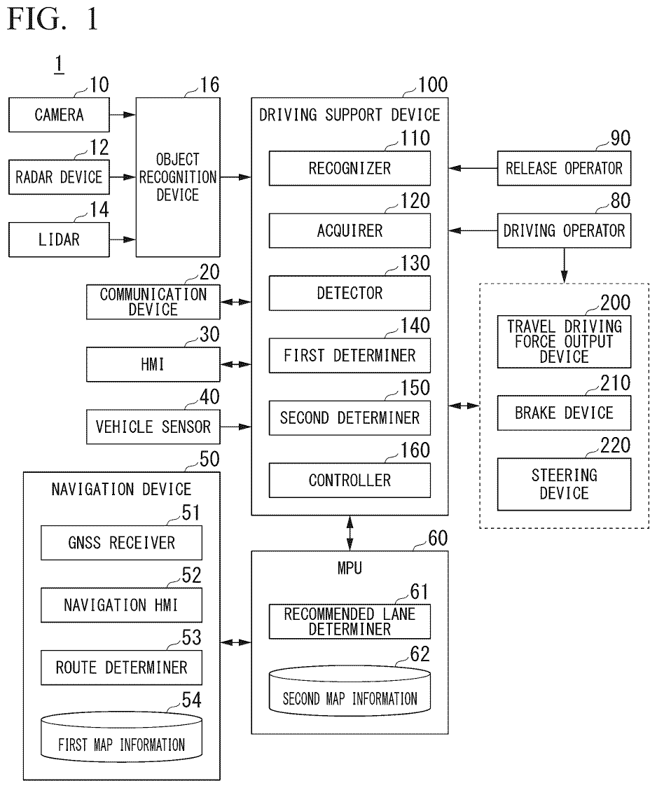

FIG. 1 is a diagram showing a configuration of a vehicle system 1 employing a vehicle control system according to an embodiment. A vehicle in which the vehicle system 1 is mounted is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

The vehicle system 1 includes, for example, a camera 10, a radar device 12, a Light Detection and Ranging (LIDAR) device 14, an object recognition device 16, a communication device 20, a human-machine interface (HMI) 30, a vehicle sensor 40, a navigation device 50, a map positioning unit (MPU) 60, a driving operator 80, a release operator 90, a driving support device 100, a travel driving force output device 200, a brake device 210, and a steering device 220. These devices or instruments are connected to each other via a multiplex communication line such as a controller area network (CAN) communication line, a serial communication line, a radio communication network, or the like. The configuration shown in FIG. 1 is only an example and a part of the configuration may be omitted or another configuration may be added thereto. The driving support device 100 is an example of a “vehicle control device.”

The camera 10 is, for example, a digital camera using a solid-state imaging device such as a charge coupled device (CCD) or a complementary metal oxide semiconductor (CMOS). The camera 10 is attached to an arbitrary position on the vehicle (hereinafter referred to as a vehicle M) in which the vehicle system 1 is mounted. When a forward view is imaged, the camera 10 is attached to an upper part of a front windshield, a rear surface of a rearview mirror, or the like. The camera 10 images the surroundings of the vehicle M, for example, periodically and repeatedly. The camera 10 may be a stereo camera.

The radar device 12 radiates radio waves such as millimeter waves to the surroundings of the vehicle M, detects radio waves (reflected waves) reflected by an object, and detects at least a position (a distance and a direction) of the object. The radar device 12 is attached to an arbitrary position on the vehicle M. The radar device 12 may detect a position and a speed of an object using a frequency modulated continuous wave (FM-CW) method. The radar device 12 is attached to, for example, front corners (left and right) of the vehicle M. Accordingly, the radar device 12 can detect an object to cross the front of the vehicle M.

The LIDAR device 14 radiates light (or electromagnetic waves of wavelengths close to light) to the surroundings of the vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the host vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 100. The object recognition device 16 may output the results of detection from the camera 10, the radar device 12, and the LIDAR device 14 to the driving support device 100 without any change. The object recognition device 16 may be omitted from the vehicle system 1.

The communication device 20 communicates with other vehicles near the vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the vehicle M and receives an input operation from the occupant. The HMI 30 includes, for example, various display devices, speakers, buzzers, touch panels, switches, and keys. The HMI 30 includes a display device. The display device is a display device, that is, a so-called multi-information display, which is provided at the center of an instrument panel of the vehicle M and displays various types of information in the vehicle M such as a speed meter (a speedometer) indicating a traveling speed of the vehicle M or a rotation speed meter (a tachometer) indicating the number of revolutions (a rotation speed) of an internal combustion engine of the vehicle M.

The vehicle sensor 40 includes a vehicle speed sensor that detects a speed of the vehicle M, an acceleration sensor that detects acceleration, a yaw rate sensor that detects an angular velocity around a vertical axis, a direction sensor that detects a direction of the vehicle M, and a sensor that detects a rotation angle of a steering wheel. The vehicle sensor 40 may include an accelerator operation amount sensor and a brake depression amount sensor. The brake depression amount sensor is a sensor that detects a change of a brake pedal due to a driver's operation.

The navigation device 50 includes, for example, a global navigation satellite system (GNSS receiver) 51, a navigation HMI 52, and a route determiner 53. The navigation device 50 stores first map information 54 in a storage device such as a hard disk drive (HDD) or a flash memory. The GNSS receiver 51 identifies a position of the vehicle M on the basis of signals received from GNSS satellites. The position of the vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory. The recommended lane determiner 61 divides the route on a map provided from the navigation device 50 into a plurality of blocks (for example, blocks every 100 [m] in a vehicle traveling direction) and determines a recommended lane for each block with reference to the second map information 62. The recommended lane determiner 61 determines in which lane from the leftmost the vehicle M is to travel. When there is a branching point in the route on a map, the recommended lane determiner 61 determines the recommended lane such that the vehicle M can travel along a rational route for traveling to a branching destination. For example, when the vehicle M arrives at a predetermined distance before a branch road to travel, the recommended lane determiner 61 determines a lane connected to the branch road as the recommended lane. The recommended lane determiner 61 and the second map information 62 may be a functional unit or information included in another device such as the driving support device 100. For example, information of the recommended lane is provided to a driver via the HMI.

The second map information 62 is map information with higher precision than the first map information 54. For example, the second map information 62 may include information of centers of lanes and information of boundaries of lanes. The second map information 62 may include road information, traffic regulation information, address information (addresses and postal codes), facility information, and phone number information. The second map information 62 may be updated from time to time by causing the communication device 20 to communicate with another device.

The operator 80 includes, for example, a steering wheel, an accelerator pedal, a brake pedal, a shift lever, and other operators. A sensor that detects an amount of operation or whether an operation has been performed is attached to the operator 80, and results of detection of the sensor are output to the driving support device 100 or some or all of the travel driving force output device 200, the brake device 210, and the steering device 220. The steering wheel does not have to have a ring shape and may have a shape of a deformed steering wheel, a joystick, a button, or the like. The accelerator pedal and the brake pedal does not have to have a shape which can be operated by being depressed by a driver's foot and may be, for example, a controller of a stick shape which is operated by a driver's hand. For example, the controller is attached to a position which can be operated by a driver on a driver's seat of a welfare vehicle. For example, when a driver's acceleration operation of pulling a controller grip of the controller is performed, the vehicle accelerates. For example, when a driver's deceleration operation of pushing the controller grip of the controller is performed, the vehicle brakes and decelerates.

The release operator 90 outputs a release instruction associated with release of vehicle control which will be described later according to a driver's operation. The release operator 90 outputs the release instruction to the driving support device 100. The release operator 90 is, for example, a switch of a button shape provided in the vicinity of the steering wheel. The release operator 90 has only to be located at a location which can be operated by a driver during driving. The shape of the release operator 90 has only to be a shape which can be operated by a driver.

The driving support device 100 includes, for example, a recognizer 110, an acquirer 120, a detector 130, a first determiner 140, a second determiner 150, and a controller 160. The recognizer 110, the acquirer 120, the detector 130, the first determiner 140, the second determiner 150, and the controller 160 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD or a CD-ROM and installed in the HDD or the flash memory of the driving support device 100 by setting the removable storage medium (a non-transitory storage medium) into a drive device. A functional configuration including some or all of the first determiner 140, the second determiner 150, and the controller 160 is an example of a “controller.”

The recognizer 110 recognizes a state such as a position, a speed, or an acceleration of an object near the vehicle M on the basis of surrounding information input from the camera 10, the radar device 12, and the LIDAR device 14 via the object recognition device 16. For example, a position of an object is recognized as a position in an absolute coordinate system with a representative point (such as the center of gravity or the center of a drive shaft) of the vehicle M as an origin and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof.

The recognizer 110 recognizes, for example, a lane of the vehicle M or another nearby lane. The lane is a lane (a traveling lane) in which the vehicle M is traveling or an oncoming lane near the traveling lane. For example, the recognizer 110 recognizes lanes by comparing a pattern of road marking lines (for example, an array of solid lines and dotted lines) acquired from the second map information 62 and a pattern of road marking lines near the vehicle M recognized from an image captured by the camera 10. The recognizer 110 is not limited to the road marking lines and may recognize lanes by recognizing lane boundaries (road boundaries) including road marking lines, roadsides, curbstones, median strips, and guard rails. In this recognition, the position of the vehicle M acquired from the navigation device 50 or the result of processing from the INS may be considered. The recognizer 110 recognizes a stop line, an obstacle, a red signal, a toll gate, or other road events near the vehicle M.

The recognizer 110 recognizes behavior of the vehicle M on the basis of the results of detection from the vehicle sensor 40. For example, the recognizer 110 recognizes a position or a posture of the vehicle M with respect to the traveling lane at the time of recognition of the traveling lane. The recognizer 110 may recognize, for example, a degree of separation of a reference point of the vehicle M from the lane center and an angle of the traveling direction of the vehicle M with respect to a line formed by connecting the lane centers as the position and the posture of the vehicle M with respect to the traveling lane. Instead, the recognizer 110 may recognize a position of a reference point of the vehicle M with respect to one side line of the traveling lane (a road marking line or a road boundary) or the like as the relative position of the vehicle M with respect to the traveling lane.

The acquirer 120 acquires a release instruction in response to a driver's operation on the release operator 90.

The detector 130 detects vehicle operation which is a driver's operation associated with traveling of the vehicle M. The vehicle operation includes, for example, an acceleration operation associated with acceleration of the vehicle M, a deceleration operation associated with deceleration of the vehicle M, and a stop operation associated with stopping of the vehicle M. The acceleration operation is, for example, an operation in which a driver operates an accelerator pedal to accelerate the vehicle M. The accelerator operation of operating the accelerator pedal is an example of the acceleration operation. The deceleration operation is, for example, an operation in which a driver operates a brake pedal to decelerate the vehicle M. The stop operation is, for example, an operation in which a driver operates the brake pedal to stop the vehicle M. The brake operation of operating the brake pedal is an example of the deceleration operation and the stop operation. The vehicle operation may include a steering operation in which a driver operates a steering wheel of the vehicle M. The detector 130 may detect whether vehicle operation has been performed or a degree of vehicle operation. The degree of vehicle operation is a degree of operation by a driver in the acceleration operation, the deceleration operation, the stop operation, and the steering operation. The degree of vehicle operation is, for example, an accelerator operation amount, a brake depression amount, or a degree of a steering angle (for example, a degree of change of a position of a steering wheel with respect to a reference position when a vehicle travels ahead). The detector 130 may detect the degree of vehicle operation on the basis of the results of detection from the vehicle sensor 40.

The first determiner 140 determines whether a type of vehicle control which will be described later and the type of vehicle operation match.

When the vehicle M is traveling on a road requiring right turn or left turn and steering control which will be described later is being performed, the second determiner 150 determines whether a difference between the degree of steering operation and a degree of steering operation based on the steering control is equal to or greater than a threshold value. For example, when the steering wheel rotates by a first degree with the steering operation based on the steering control and the steering wheel has rotated by a threshold value greater than the first degree with a driver's steering operation, it is determined that the difference is equal to or greater than the threshold value. The threshold value may be set in advance or may be set by a driver. The threshold value may be set, for example, according to a width of the traveling lane. The threshold value may be set to different values when rotation directions of the steering wheel are the same direction and when the rotation directions are opposite.

The controller 160 controls the constituents of the driving support device 100 and the vehicle system 1 as a whole. For example, the controller 160 controls the HMI 30 such that information is provided to a driver. For example, the controller 160 performs vehicle control which is automated driving or driving support of the vehicle M on the basis of the surrounding information of the vehicle M recognized by the recognizer 110. The vehicle control includes, for example, acceleration control associated with acceleration of the vehicle M, deceleration control associated with deceleration of the vehicle M, and stop control associated with stopping of the vehicle M. The vehicle control may include steering control for controlling steering of the vehicle M. The acceleration control can be control for accelerating the vehicle M. The deceleration control can be control for decelerating the vehicle M. The stop control can be control for stopping the vehicle M. The steering control can be control for changing the traveling direction of the vehicle M.

The driving support includes, for example, an adaptive cruise control system (ACC) or a lane keeping assistance system (LKAS). When the ACC is operating, the controller 160 performs control such that the vehicle M travels in a state in which a distance to another vehicle preceding the vehicle M is maintained constant on the basis of the surrounding information. That is, the controller 160 performs control such that the vehicle M travels at a speed corresponding to the preceding vehicle. For example, the controller 160 performs control such that the vehicle M accelerates when the preceding vehicle accelerates, and the controller 160 performs control such that the vehicle M decelerates when the preceding vehicle decelerates. When there is no preceding vehicle, the controller 160 may perform control such that the vehicle M travels while keeping an arbitrary set speed. When the LKAS is operating, the controller 160 performs control such that the vehicle M travels at the lane center or in the vicinity of the lane center on the basis of the lane recognized by the recognizer 110. For example, when the vehicle M travels in a direction in which the vehicle M is likely to depart the lane, the controller 160 may support the steering operation and perform control such that the vehicle M approaches the lane center or the vicinity of the lane center. The driving support includes control for stopping the vehicle M on the basis of the surrounding information. For example, when a stop line, a red signal, or a stopped preceding vehicle is recognized, the controller 160 may perform control such that the vehicle M stops safely. For example, the controller 160 stops the vehicle M before the stop line, on a stop line corresponding to the red signal, or in the vicinity of the stop line. For example, the controller 160 stops the vehicle M a predetermined distance from the stopped preceding vehicle. The ACC is an example of the acceleration control, the deceleration control, and the stop control. The LKAS is an example of the steering control. The acceleration control or the deceleration control is not limited to the ACC and has only to be control for automatically controlling the speed of the vehicle M according to the surrounding situation or the set speed. The steering control is not limited to the LKAS and has only to be control for automatically controlling the steering of the vehicle M according to the surrounding situation or a road marking line.

When automated driving is performed, the controller 160 generates a target trajectory such that the vehicle M does not pass through a spot with a risk equal to or greater than a predetermined value and travels in a recognized lane or the traveling lane. For example, the target trajectory is expressed by sequentially arranging points (trajectory points) at which the vehicle M is to arrive. Trajectory points are points at which the vehicle M is to arrive at intervals of a predetermined traveling distance (for example, about several [m]) along a road, and a target speed and a target acceleration at every interval of a predetermined sampling time (for example, below the decimal point [sec]) are generated as a part of the target trajectory in addition thereto. The trajectory points may be positions at which the vehicle M is to arrive at sampling times every predetermined sampling time. In this case, information of the target speed or the target acceleration is expressed by intervals between the trajectory points. The controller 160 performs control such that the vehicle M travels along the target trajectory. For example, when the vehicle M approaches a crossing, the controller 160 generates a target trajectory such that the vehicle turns to right and enters a crossing road to a destination. The controller 160 controls the vehicle M such that the vehicle M travels along the generated trajectory.

Detailed processes of the first determiner 140, the second determiner 150, and the controller 160 will be described later.

The travel driving force output device 200 outputs a travel driving force (a torque) for allowing the vehicle M to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the driving support device 100 or information input from the operator 80.

The brake device 210 includes, for example, a brake caliper, a cylinder that transmits a hydraulic pressure to the brake caliper, an electric motor that generates a hydraulic pressure in the cylinder, and a brake ECU. The brake ECU controls the electric motor on the basis of the information input from the driving support device 100 or the information input from the operator 80 such that a brake torque based on a braking operation is output to vehicle wheels.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the driving support device 100 or the information input from the operator 80 and changes the direction of the turning wheels.

### SUMMARY

In the present embodiment, the controller 160 releases vehicle control when a type of vehicle control and a type of vehicle operation match and a release instruction is acquired. “The type of vehicle control and the type of vehicle operation match” means that behavior of the vehicle M intended by a driver based on vehicle operation and behavior of the vehicle M intended in vehicle control match.

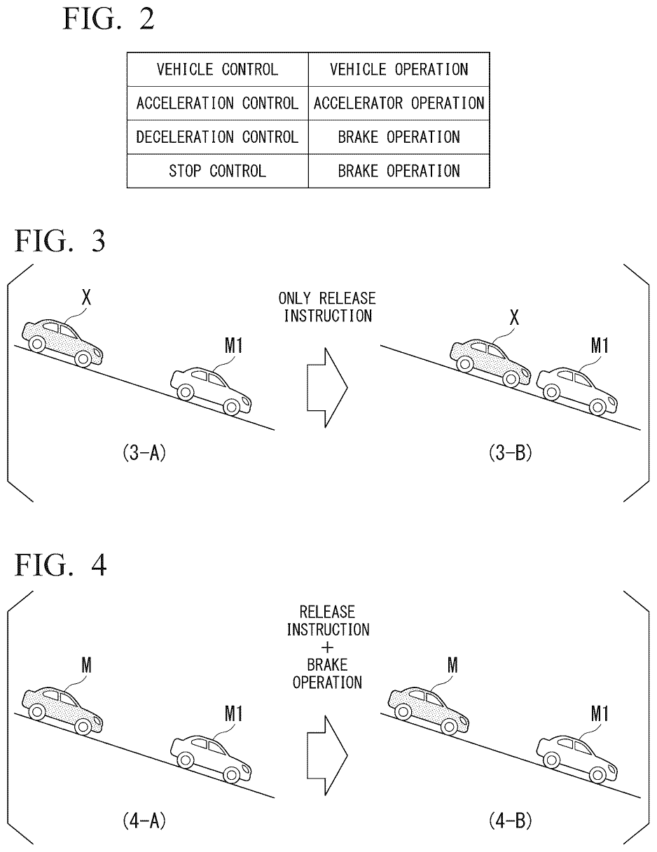

FIG. 2 is a diagram showing an example of a correlation between a type of vehicle control and a type of vehicle operation when the types match. In FIG. 2, types of vehicle control are shown in the left part, and types of vehicle operation are shown in the right part. The vehicle control type and the vehicle operation type shown in the same row match. When the vehicle control type is acceleration control, the vehicle operation type matched therewith is an accelerator operation. When the vehicle control type is deceleration control, the vehicle operation type matched therewith is a brake operation. When the vehicle control type is stop control, the vehicle operation type matched therewith is a brake operation.

### Process Details

### Situation 1-1

In a situation in which acceleration control is being performed by the controller 160, the controller 160 releases the acceleration control when the type of vehicle control (acceleration control) and the type of vehicle operation match and a release instruction is acquired. At this time, vehicle control such as deceleration control and steering control may be simultaneously released in addition to the acceleration control.

A process in Situation 1-1 will be described in detail. The acceleration control is performed by the controller 160, and the vehicle M is traveling in a lane while accelerating. In this situation, when vehicle operation is detected by the detector 130, the first determiner 140 determines whether the type of vehicle control (acceleration control) and the type of vehicle operation match. When an accelerator operation is performed by a driver, the first determiner 140 determines that the vehicle control type and the vehicle operation type match. When an operation (for example, a brake operation) other than the accelerator operation is performed by a driver, the first determiner 140 determines that the vehicle control type and the vehicle operation type do not match. When the vehicle control type and the vehicle operation type do not match, the controller 160 continues to perform the vehicle control (acceleration control) even if a driver performs an operation on the release operator 90.

When the vehicle control type and the vehicle operation type match, the controller 160 determines whether a release instruction has been acquired by the acquirer 120. When a release instruction has not been acquired, the controller 160 continues to perform the vehicle control (acceleration control). When a release instruction has been acquired, the controller 160 releases the vehicle control (acceleration control), and the vehicle M is controlled by a driver's operation. That is, in a situation in which acceleration control is being performed, a driver can release the vehicle control (acceleration control) of the controller 160 by performing the vehicle operation matching the acceleration control, that is, the accelerator operation, and operating the release operator 90.

When the degree of acceleration operation (accelerator operation) detected by the detector 130 satisfies a first condition, the first determiner 140 may determine whether the vehicle control type matches the acceleration operation (accelerator operation) satisfying the first condition. The degree of accelerator operation may be, for example, an acceleration based on the accelerator operation, an accelerator operation amount, or a change of the accelerator pedal. The first condition may be, for example, a condition in which the acceleration based on the accelerator operation is equal to or greater than an acceleration based on acceleration control or a condition in which the accelerator operation amount based on the accelerator operation is equal to or greater than a predetermined value. For example, the predetermined value may change according to the speed of the vehicle M. The first condition can be a condition in which a speed based on the accelerator operation is equal to or greater than a speed based on vehicle control. When the vehicle control type and the vehicle operation type match and a driver has performed an operation on the release operator 90 in a state in which the degree of acceleration operation (accelerator operation) detected by the detector 130 has satisfied the first condition, the first determiner 140 may release the acceleration control.

In this way, when the degree of acceleration operation satisfies the first condition, it is possible to appropriately release vehicle control in consideration of a driver's operation state of the vehicle M by determining whether to release the vehicle control on the basis of the result of determination of whether the vehicle control type and the vehicle operation type match and whether a release instruction has been acquired. For example, when the vehicle M is accelerated through acceleration control in a straight lane, the detector 130 detects an accelerator operation (acceleration operation) satisfying the first condition, and the acquirer 120 acquires a release instruction, the controller 160 releases the vehicle control. By releasing the vehicle control in this condition and switching to traveling based on the vehicle operation, the vehicle control is released when a driver has an intention of releasing the vehicle control, and the vehicle M travels without deceleration even after the vehicle control has been released. When the degree of acceleration operation satisfies the first condition, appropriate behavior of the vehicle M is maintained even when the vehicle control is released and switched to traveling based on the vehicle operation by determining whether to release the vehicle control on the basis of the result of determination of whether the vehicle control type and the vehicle operation type match and whether a release instruction has been acquired.

### Situation 1-2

In a situation in which deceleration control is being performed by the controller 160, the controller 160 releases the deceleration control when the type of vehicle control (deceleration control) and the type of vehicle operation match and a release instruction is acquired. At this time, vehicle control such as acceleration control and steering control may be simultaneously released in addition to the deceleration control.

A process in Situation 1-2 will be described in detail. The deceleration control is performed by the controller 160, and the vehicle M is traveling in a lane while decelerating. In this situation, when vehicle operation is detected by the detector 130, the first determiner 140 determines whether the type of vehicle control (deceleration control) and the type of vehicle operation match. When a brake operation is performed by a driver, the first determiner 140 determines that the vehicle control type and the vehicle operation type match. When an operation (for example, an accelerator operation) other than the brake operation is performed by a driver, the first determiner 140 determines that the vehicle control type and the vehicle operation type do not match. When the vehicle control type and the vehicle operation type do not match, the controller 160 continues to perform the vehicle control (deceleration control) even if a driver performs an operation on the release operator 90.

When the vehicle control type and the vehicle operation type match, the controller 160 determines whether a release instruction has been acquired by the acquirer 120. When a release instruction has not been acquired, the controller 160 continues to perform the vehicle control (deceleration control). When a release instruction has been acquired, the controller 160 releases the vehicle control (deceleration control), and the vehicle M is controlled by a driver's operation. That is, in a situation in which deceleration control is being performed, a driver can release the vehicle control (deceleration control) of the controller 160 by performing the vehicle operation matching the deceleration control, that is, the brake operation, and operating the release operator 90.

When the degree of deceleration operation (brake operation) detected by the detector 130 satisfies a second condition, the first determiner 140 may determine whether the vehicle control type matches the deceleration operation (brake operation) satisfying the second condition. The degree of brake operation may be, for example, a deceleration based on the brake operation or a brake depression amount. The second condition may be, for example, a condition in which the deceleration based on the brake operation is equal to or greater than a deceleration based on deceleration control or a condition in which the brake operation amount based on the brake operation is equal to or greater than a predetermined value. For example, the predetermined value may change according to the speed of the vehicle M. The second condition can be a condition in which a speed based on the brake operation is equal to or greater than a speed based on vehicle control. When the vehicle control type and the vehicle operation type match and a driver has performed an operation on the release operator 90 in a state in which the degree of deceleration operation (brake operation) detected by the detector 130 has satisfied the second condition, the first determiner 140 may release the deceleration control.

### Situation 1-3

In a situation in which stop control is being performed by the controller 160, the controller 160 releases the stop control when the type of vehicle control (stop control) and the type of vehicle operation match and a release instruction is acquired. At this time, vehicle control such as deceleration control and steering control may be simultaneously released in addition to the stop control.

FIG. 3 is a diagram showing a comparative example. (3-A) in the drawing indicates a situation in which stop control is being performed, and (3-B) in the drawing indicates a situation in which stop control is released. In (3-A) in the drawing, a vehicle X and another vehicle M1 stop in a tilted lane. The vehicle X is located behind the other vehicle M1. The vehicle X and the other vehicle M1 stop downhill. In (3-B) of the drawing, the other vehicle M1 stops at the same position as in (3-A) of the drawing, and the vehicle X is in a state in which a driver performs no vehicle operation and stop control is released. At this time, since the stop control is released, the vehicle X moves forward due to the tilt of the traveling lane, and the vehicle X and the other vehicle M1 are closer to each other than that in (3-A) of the drawing. When the vehicle control (stop control) is released on the basis of the assumption that a release instruction is acquired without considering whether the vehicle control type and the vehicle operation type match, there is a likelihood that behavior of the vehicle X may not match before and after the vehicle control (stop control) is released. In this case, there is concern that the vehicle X and the other vehicle M1 will approach as shown in FIG. 3.

FIG. 4 is a diagram showing an example of a situation in which stop control is released in the present embodiment. FIG. 4 shows an image in which a vehicle M and another vehicle M1 in front of the vehicle M are present in a tilted lane which is the same as shown in FIG. 3. (4-A) of the drawing indicates a situation in which stop control is being performed, and (4-B) of the drawing indicates a situation in which stop control has been released. (4-A) of the drawing is the same situation as (3-A) of FIG. 3. The vehicle M and the other vehicle M1 stop downhill. In (4-B) of the drawing, the vehicle M and the other vehicle M1 are located at the same position as in (4-A) of the drawing.

In (4-A) of the drawing, when vehicle operation is detected by the detector 130, the first determiner 140 determines whether the vehicle control type (stop control) and the vehicle operation type match. When a brake operation is being performed by a driver, the first determiner 140 determines that the vehicle control type and the vehicle operation type match. When an operation (for example, an accelerator operation) other than the brake operation is being performed by a driver, the first determiner 140 determines that the vehicle control type and the vehicle operation type do not match. When the vehicle control type and the vehicle operation type do not match, the controller 160 continues to perform the vehicle control (stop control).

When the vehicle control type and the vehicle operation type match, the controller 160 determines whether a release instruction has been acquired by the acquirer 120. When a release instruction has not been acquired, the controller 160 continues to perform the vehicle control (stop control). When a release instruction has been acquired, the controller 160 releases the vehicle control (stop control), and the vehicle M is controlled by the driver's operation. In (4-A) of the drawing, since the brake operation is being performed by the driver, the vehicle M stops at the same position as in (4-A) of the drawing even in (4-B) of the drawing in which the stop control has been released.

When a degree of stop operation (brake operation) detected by the detector 130 satisfies a third condition, the first determiner 140 may determine whether the vehicle control type and the vehicle operation type match. The third condition can be a condition in which the vehicle M is stopped by a brake operation. The third condition may change according to conditions of the traveling road of the vehicle M, the weather, or the like. For example, the degree of stop operation which is the third condition may be set to be larger as a road slope becomes larger, and the degree of stop operation which is the third condition may be set to be smaller as the road slope becomes smaller. When the road is predicted to be slippery such as in the rainy weather, the degree of stop operation which is the third condition may be set to be large.

### Flowchart 1

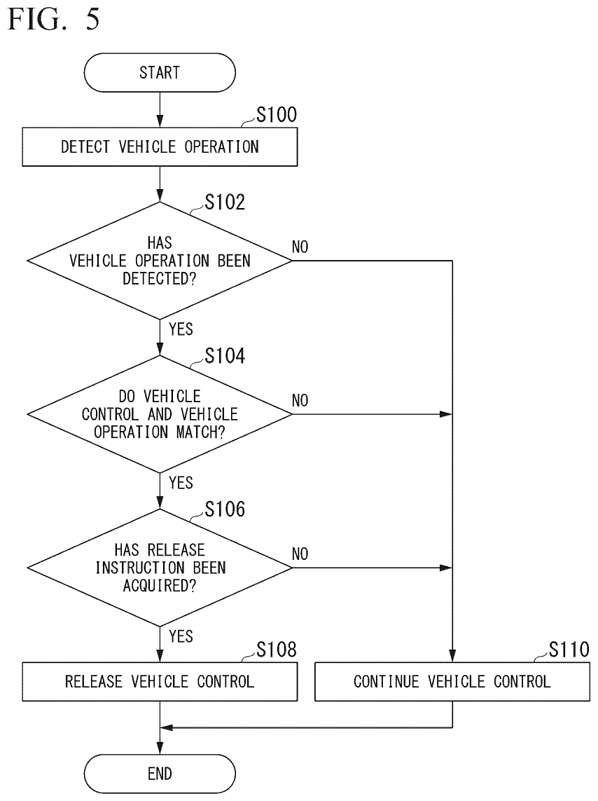

FIG. 5 is a flowchart showing an example of a process flow that is performed by the driving support device 100. For example, the process flow in the flowchart shown in FIG. 5 is performed at intervals of a predetermined period while performing vehicle control.

First, the detector 130 detects a vehicle operation (Step S100). The vehicle operation in the process of Step S100 is, for example, an accelerator operation or a brake operation. Then, the detector 130 determines whether a vehicle operation has been detected (Step S102). When a vehicle operation has been detected (Step S102: YES), the first determiner 140 determines whether the vehicle control type and the vehicle operation type match (Step S104). When the vehicle control type and the vehicle operation type match (Step S104: YES), the controller 160 determines whether a release instruction has been acquired (Step S106). When a release instruction has been acquired (Step S106: YES), the controller 160 releases the vehicle control (Step S108). When no vehicle operation has been detected (Step S102: NO), the vehicle control type and the vehicle operation type do not match (Step S104: NO), or a release instruction has not been acquired (Step S106: NO), the controller 160 continues to perform the vehicle control (Step S110). After the process of Step S108 has ended or after the process of S110 has ended, the process flow of the flowchart ends.

As described above in Situations 1-1 to 1-3 and Flowchart 1, by releasing the vehicle control when the vehicle control type and the vehicle operation type match and a release instruction has been acquired, it is possible to appropriately release the vehicle control. For example, when a brake operation of stopping the vehicle M is performed by a driver while the controller 160 is performing stop control and a release instruction is acquired by the acquirer 120, the first determiner 140 determines that the vehicle control type and the vehicle operation type match, and the controller 160 releases the stop control. In this situation, the vehicle M continues to stop by the brake operation even after the stop control has been released. In this way, since the vehicle control is released when behavior of the vehicle M based on the vehicle control and behavior intended by the vehicle operation match and a driver has an intention of releasing the vehicle control, it is possible to appropriately release the vehicle control at the timing intended by the driver, and the vehicle M continues to adopt stable behavior even after the vehicle control has been released.

### Situation 2

When steering control is being performed, it is determined that the vehicle control type (for example, acceleration control or deceleration control) and the vehicle operation type match, and a steering operation is performed by a driver, the controller 160 releases the vehicle control regardless of whether a release instruction has been acquired. The vehicle control to be released at this time may be acceleration control, deceleration control, or both of acceleration control or deceleration control and steering control or may be all of acceleration control, deceleration control, and steering control.

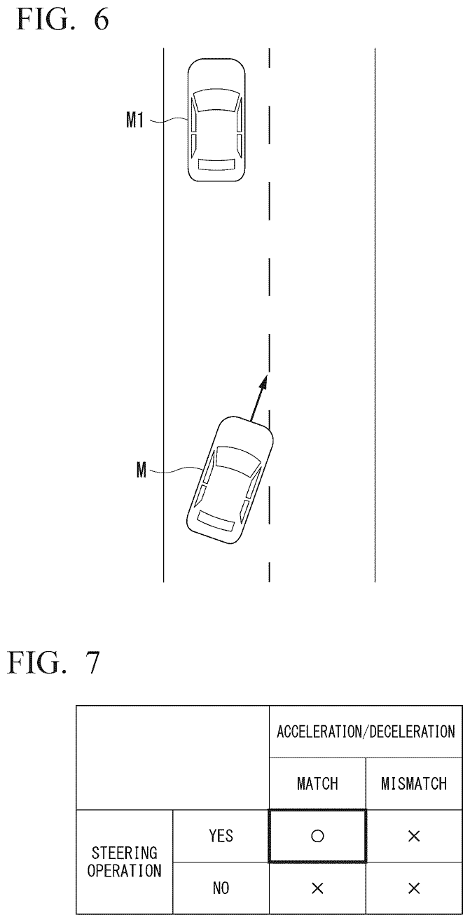

FIG. 6 is a diagram showing an example of a situation in which acceleration control is released in the present embodiment. In FIG. 6, the vehicle M changes the traveling direction and accelerates to overtake another vehicle M1 preceding. Change of the traveling direction and acceleration of the vehicle M in FIG. 6 are based on steering control and acceleration control which are being performed by the controller 160.

In this situation, when a vehicle operation has been detected by the detector 130, the first determiner 140 determines whether the vehicle control type (acceleration control) and the vehicle operation type match and whether the steering operation has been performed. When the accelerator operation is being performed by a driver, the first determiner 140 determines that the vehicle control type and the vehicle operation type match. When an operation (for example, a brake operation) other than the accelerator operation is being performed by a driver, the first determiner 140 determines that the vehicle control type and the vehicle operation type do not match. The first determiner 140 determines that the steering operation has been performed when the steering operation is being performed by a driver and determines that the steering operation has not been performed when the steering operation is not being performed by a driver. When it is determined that the vehicle control type (acceleration control) and the vehicle operation type match and it is determined that the steering operation has been performed, the controller 160 releases the vehicle control (steering control and acceleration control) regardless of whether a driver has performed an operation on the release operator 90. When it is determined that the vehicle control type (acceleration control) and the vehicle operation type do not match or/and when it is determined that the steering operation has not been performed, the controller 160 continues to perform the vehicle control (steering control and acceleration control).

In this way, by releasing the vehicle control on the basis of the assumption that a driver performs the accelerator operation and the steering operation when the vehicle M is scheduled to change the lane and overtake the other vehicle M1 preceding and lane change based on the steering control and acceleration based on the acceleration control are performed, it is possible to release the vehicle control without damaging convenience to the driver when the driver has an intention of releasing the vehicle control.

When the steering control and the deceleration control are being performed by the controller 160, similarly to the aforementioned process, the controller 160 releases the vehicle control (steering control and acceleration control) regardless of whether a driver has performed an operation on the release operator 90 when it is determined that the vehicle control type (deceleration control) and the vehicle operation type match and it is determined that the steering operation has been performed. When it is determined that the vehicle control type (deceleration control) and the vehicle operation type do not match or/and when it is determined that the steering operation has not been performed, the controller 160 continues to perform the vehicle control (steering control and deceleration control). In the aforementioned example, the controller 160 has released both the steering control and the acceleration control or the deceleration control, but only the acceleration control or the deceleration control may be released.

In Situation 2, when the degree of accelerator operation satisfies the first condition or the degree of brake operation satisfies the second condition, the first determiner 140 may determine whether the vehicle control type and the vehicle operation type match.

FIG. 7 is a diagram showing a condition for releasing the vehicle control when steering control and acceleration control or deceleration control are being performed. An O mark in the drawing indicates a condition in which the vehicle control is released regardless of whether a release instruction has been acquired, and an X mark in the drawing indicates a condition in which the vehicle control is not released. In FIG. 7, when acceleration/deceleration is match, that is, when the accelerator operation is performed while acceleration control is being performed or the brake operation is performed while deceleration control is being performed, and when steering (steering operation) has been performed, the controller 160 satisfies the condition for releasing the vehicle control. When the condition is not satisfied, that is, when acceleration/deceleration mismatch or steering has not been performed, the controller 160 determines that the condition for releasing the vehicle control is not satisfied. In other words, when the condition is not satisfied, the controller 160 determines that the condition for continuing the vehicle control is satisfied.

### Flowchart 2

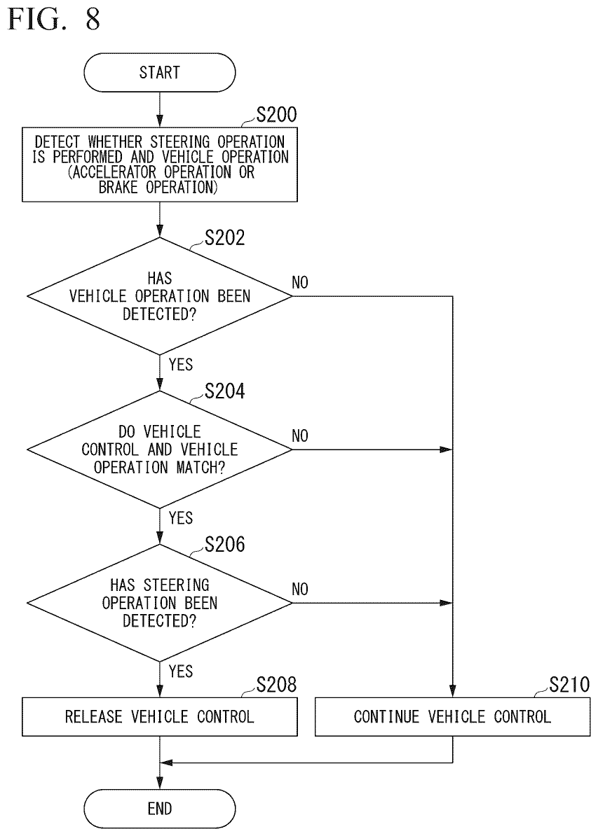

FIG. 8 is a flowchart showing an example of a process flow that is performed by the driving support device 100. The process flow in the flowchart shown in FIG. 8 is performed at intervals of a predetermined period, for example, when acceleration control or deceleration control and steering control are being performed.

First, the detector 130 detects whether a steering operation has been performed and a vehicle operation (Step S200). The vehicle operation in the process of Step S200 is, for example, an accelerator operation or a brake operation. Then, the detector 130 determines whether the vehicle operation has been detected (Step S202). When the vehicle operation has been detected (Step S202: YES), the first determiner 140 determines whether the vehicle control type and the vehicle operation type match (Step S204). When the vehicle control type and the vehicle operation type match (Step S204: YES), the first determiner 140 determines whether the steering operation has been detected (Step S206). When the steering operation has been detected (Step S206: YES), the controller 160 releases the vehicle control (Step S208). In Step S208, the controller 160 may release the acceleration control or the deceleration control and the steering control. When the vehicle operation has not been detected (Step S202: NO), the vehicle control type and the vehicle operation type do not match (Step S204: NO), or the steering operation has not been detected (Step S206: NO), the controller 160 continues to perform the vehicle control (Step S210). After the process of Step S208 has ended or after the process of Step S210 has ended, the process flow of the flowchart ends.

In this way, when steering control and vehicle control other than the steering control are being performed, it is possible to appropriately switch from control of the vehicle M based on the vehicle control to control of the vehicle M intended by a driver by releasing the vehicle control when it is determined that the vehicle control type other steering control and the vehicle operation type match and the steering operation has been performed by the driver.

### Situation 3

When a driver's acceleration operation has been detected while performing stop control, the controller 160 releases the stop control.

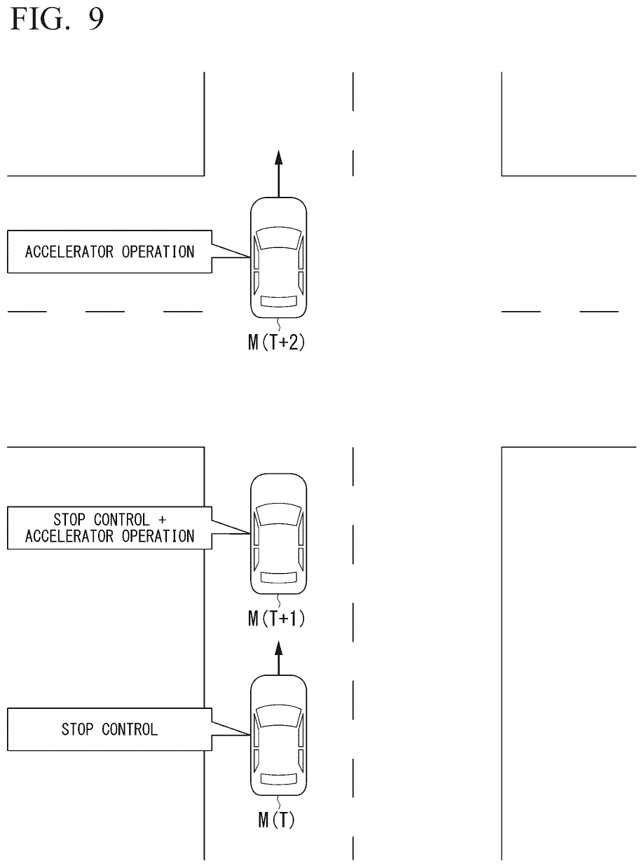

FIG. 9 is a diagram illustrating an example of a situation in which stop control is released by an acceleration operation in the present embodiment. In FIG. 9, a situation in which the vehicle M stops at a crossing and then travels ahead is shown. At time T, stop control for stopping the vehicle M before a crossing is performed by the controller 160, and the vehicle M travels ahead while decelerating. After a predetermined time has elapsed from time T, the vehicle M stops before the crossing. Stop control of the vehicle M is also performed by the controller 160 during stop. At time T+1, the detector 130 detects a driver's acceleration operation (acceleration operation). At time T+1, the controller 160 is performing the stop control. In this case, since the accelerator operation has been detected while performing the stop control, the controller 160 releases the stop control. At time T+2, the stop control is released, and the vehicle M travels through the crossing by the driver's accelerator operation.

In this way, by releasing the stop control when a driver's acceleration operation has been detected while the stop control is being performed, it is possible to appropriately start the vehicle M according to the driver's intention. For example, in a situation in which it is preferable to quickly start the vehicle M during stop, it is possible to shorten the time required for releasing the stop control and to quickly start the vehicle M according to a driver's intention by releasing the stop control when a driver's acceleration operation has been detected while performing the stop control.

The controller 160 may release the vehicle control when the vehicle control type and the vehicle operation type match and a release instruction has been acquired in a situation in which the road is a gradient road and may release the vehicle control through the process even when the vehicle control type and the vehicle operation type mismatch in a situation in which the road is a flat road. The controller 160 may release the stop control when a driver's acceleration operation has been detected while the stop control is being performed on a flat road and may not release the stop control when a driver's acceleration operation has been detected while the stop control is being performed on a non-flat road (a gradient road). For example, the controller 160 releases the stop control when an operation of stopping the vehicle M such as a driver's brake operation has been detected, and a driver has operated the release operator 90 while the stop control is being performed on a road with a descending gradient or an ascending gradient. The flat road is a road on which the vehicle M does not move due to the slope of the road.

A situation in which the controller 160 performs only the stop control has been described above, but the controller 160 may release only the stop control or release the stop control and the steering control by detecting the accelerator operation while the stop control is being performed when the steering control is being performed at the same time as the stop control. A condition in which the vehicle M stops may be added as the condition for releasing only the stop control by detecting the accelerator operation while the stop control is being performed. In this case, when the vehicle M is decelerating for stopping through the stop control, the stop control is not released even if the accelerator operation has been detected.

### Situation 4

When the vehicle M is traveling on a road requiring right turn or left turn, a steering operation has been detected while steering control is being performed, and a difference between the degree of steering operation and the degree of steering control is equal to or greater than a threshold value, the controller 160 releases the vehicle control. The road requiring right turn or left turn is, for example, a crossing.

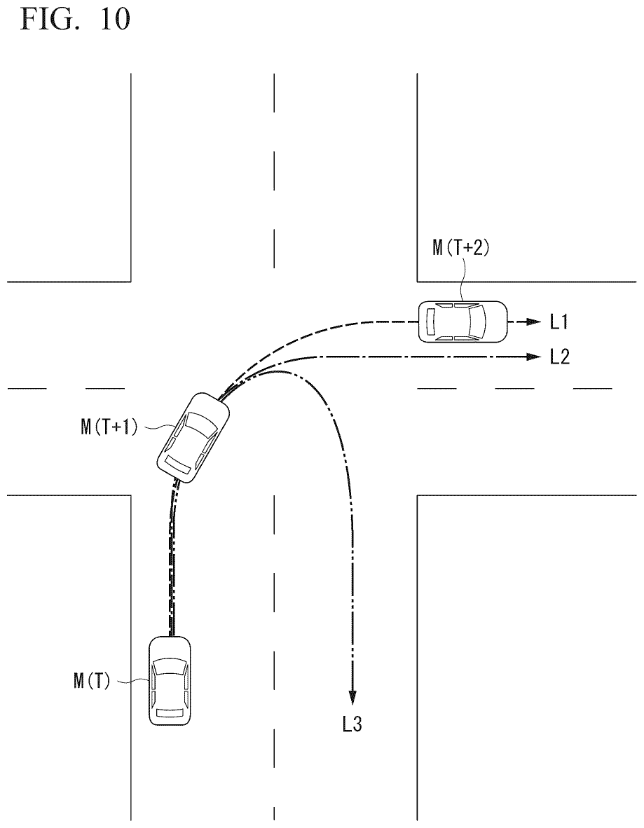

FIG. 10 is a diagram showing an example of a situation in which steering control is released in the present embodiment. In the situation shown in FIG. 10, the vehicle M enters a crossing under the steering control. A predicted route L1 is a predicted route for the vehicle M derived by the driving support device 100 on the basis of the surrounding situation of the vehicle M recognized by the recognizer 110. A desired route L2 and a desired route L3 are an example of a route of the vehicle M desired by a driver. The predicted route L1 and the desired route L2 and the desired route L3 are different routes. At time T, the vehicle M travels under the vehicle control. At time T+1, the controller 160 performs steering control of the vehicle M along the predicted route L1. At this time, when the route for the vehicle M intended by a driver is the desired route L2 or the desired route L3, the driver performs a steering operation. When the detector 130 detects the steering operation while the vehicle M is traveling at a crossing and steering control is being performed, the second determiner 150 determines whether a difference between the degree of steering control and the degree of steering operation is equal to or greater than a threshold value. The degree of steering control may be, for example, an angle of the traveling direction of the vehicle M which is changed through the steering control or a degree of steering rotation based on the steering control. The degree of steering operation may be an angle of the traveling direction of the vehicle M intended by a driver through the steering operation or a degree of steering rotation based on the steering operation.

When the difference between the degree of steering control and the degree of steering operation is not equal to or greater than the threshold value, the controller 160 continues to perform the vehicle control. In this case, at time T+2, the vehicle M travels along the predicted route L1. When the difference between the degree of steering control and the degree of steering operation is equal to or greater than the threshold value, the controller 160 releases the vehicle control (steering control). In this case, at time T+2, the vehicle M travels along a route desired by the driver. That is, the vehicle M travels along the desired route L2 or the desired route L3 in FIG. 10.

At time T+2, when vehicle control other than the steering control is performed and the difference between the degree of steering control and the degree of steering operation is equal to or greater than the threshold value, the controller 160 may release all the vehicle controls under execution or may release only the steering control.

### Flowchart 3

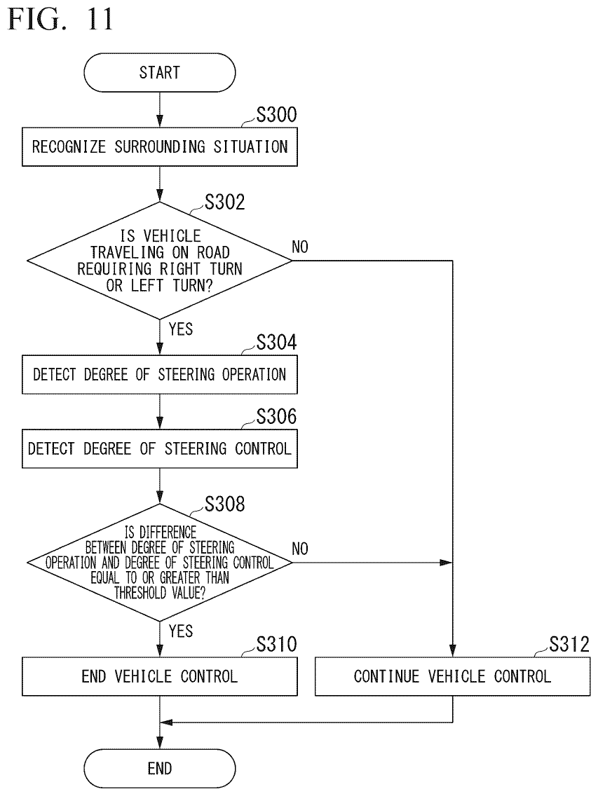

FIG. 11 is a flowchart showing an example of a process flow that is performed by the driving support device 100. The process flow in the flowchart shown in FIG. 11 is performed at intervals of a predetermined period, for example, when the vehicle M is traveling. In this process flow, the driving support device 100 performs automatic steering control.

First, the recognizer 110 recognizes the surrounding situation of the vehicle M (Step S300). Then, the controller 160 determines whether the vehicle M is traveling on a road requiring left or right turn (Step S302). When the vehicle M is traveling on a road requiring left or right turn (Step S302: YES), the detector 130 detects the degree of steering operation (Step S304). Then, the controller 160 detects the degree of steering control (Step S306). Then, the second determiner 150 determines whether a difference between the degree of steering control and the degree of steering operation is equal to or greater than a threshold value (Step S308). When the difference between the degree of steering control and the degree of steering operation is equal to or greater than the threshold value (Step S308: YES), the controller 160 ends the vehicle control (the steering control) (Step S310). When the vehicle M is not traveling on a road requiring left or right turn (Step S302: NO) or the difference between the degree of steering control and the degree of steering operation is less than the threshold value (Step S308: NO), the controller 160 continues to perform the vehicle control (Step S312).

In this way, when the vehicle M is traveling on a road requiring left or right turn, the steering operation has been detected while the steering control is being performed, and the difference between the degree of steering control and the degree of steering operation is equal to or greater than the threshold value, it is possible to perform appropriate control of the vehicle M corresponding to a driver's intention by releasing the vehicle control. For example, by releasing the steering control when the predicted route L1 along which the vehicle M travels through the steering control is a route different from the desired route L2 desired by the driver, the driver performs the steering operation, and the difference between the degree of steering control and the degree of steering operation equal to or greater than the threshold value, it is possible to release the steering control when the driver desires a route other than the predicted route L1. By releasing the steering control when the driver desires a route other than the predicted route L1, it is possible to perform appropriate control of the vehicle M corresponding to the driver's intention when the vehicle M is traveling on a road requiring left or right turn.

The above-mentioned embodiment can be expressed as follows:
A vehicle control device including:
a storage device configured to store a program; and
a hardware processor,
wherein the hardware processor executes the program stored in the storage device to perform:
   detecting a vehicle operation, the vehicle operation being a driver's operation associated with traveling of a vehicle;
   performing vehicle control on the basis of a surrounding environment of the vehicle, the vehicle control being automated driving or driving support of the vehicle;
   acquiring a release instruction associated with release of the vehicle control according to the driver's operation on a release operator;
   determining whether a type of the vehicle control and a type of the vehicle operation match;
   releasing the vehicle control when the release instruction is acquired and it is determined that the type of the vehicle control and the type of the vehicle operation match; and
   continuously performing the vehicle control when the release instruction is acquired and it is determined that the type of the vehicle control and the type of the vehicle operation do not match.

While an embodiment of the present invention has been described above, the present invention is not limited to the embodiment, and various modifications and substitutions can be added thereto without departing from the gist of the present invention.

What is claimed is:

1. A vehicle control device comprising:
a storage medium storing computer-readable instructions; and
one or more processors connected to the storage medium, the one or more processors executing the computer-readable instructions to:
detect a vehicle operation, the vehicle operation being a driver's operation associated with traveling of a vehicle;
perform vehicle control on the basis of a surrounding environment of the vehicle, the vehicle control being automated driving or driving support of the vehicle;
acquire a release instruction associated with release of the vehicle control according to the driver's operation on a release operator;
determine whether a type of the vehicle control and a type of the vehicle operation match;
release the vehicle control
when
the release instruction is acquired and
it is determined that the type of the vehicle control and the type of the vehicle operation match; and
continuously perform the vehicle control
when
the release instruction is acquired and
it is determined that the type of the vehicle control and the type of the vehicle operation do not match.

2. The vehicle control device according to claim 1,
wherein the type of the vehicle control includes some or all of acceleration control associated with acceleration, deceleration control associated with deceleration, and stop control associated with stopping, and
wherein the type of the vehicle operation includes some or all of acceleration operation associated with the acceleration, deceleration operation associated with the deceleration, and stop operation associated with the stopping.

3. The vehicle control device according to claim 2, wherein the one or more processors execute the computer-readable instructions to
determine whether the type of the vehicle control matches the acceleration operation satisfying a first condition
when a degree of the acceleration operation satisfies the first condition.

4. The vehicle control device according to claim 2, wherein the one or more processors execute the computer-readable instructions to
determine whether the type of the vehicle control matches the deceleration operation satisfying a second condition
when a degree of the deceleration operation satisfies the second condition.

5. The vehicle control device according to claim 3, wherein the one or more processors execute the computer-readable instructions to
release the acceleration control
when it is determined that the type of the vehicle control and the type of the vehicle operation match
as the acceleration operation is detected while performing the acceleration control, and
when the release instruction is acquired.

6. The vehicle control device according to claim 4, wherein the one or more processors execute the computer-readable instructions to
release the deceleration control
when it is determined that the type of the vehicle control and the type of the vehicle operation match
as the deceleration operation is detected while performing the deceleration control, and
when the release instruction is acquired.

7. The vehicle control device according to claim 2, wherein the one or more processors execute the computer-readable instructions to
release the stop control
when it is determined that the type of the vehicle control and the type of the vehicle operation match
as the stop operation is detected while performing the stop control, and
when the release instruction is acquired.

8. The vehicle control device according to claim 2, wherein the one or more processors execute the computer-readable instructions to:
detect whether a steering operation is being performed, the steering operation being the driver's steering operation; and
release the acceleration control or the deceleration control, both of the acceleration control or the deceleration control and the steering control, or all of the acceleration control, the deceleration control, and the steering control regardless of whether the release instruction has been acquired
when
the steering control included in the vehicle control is being performed,
the steering operation is detected, and
it is determined that the acceleration control or the deceleration control included in the vehicle control matches the type of the vehicle operation.

9. The vehicle control device according to claim 2, wherein the one or more processors execute the computer-readable instructions to
release the stop control
when the acceleration operation is detected while performing the stop control.

10. The vehicle control device according to claim 1, wherein the one or more processors execute the computer-readable instructions to:
detect a degree of the driver's steering operation;
determine whether a difference between the degree of the steering operation and a degree of a steering operation based on the steering control is equal to or greater than a threshold value
when
the vehicle is traveling on a road requiring right turn or left turn and
steering control of the vehicle is being performed; and
release the vehicle control
when the difference between the degree of steering operation and the degree of steering control is equal to or greater than the threshold value.

11. A vehicle control method that is performed by a computer, the vehicle control method comprising:
detecting a vehicle operation, the vehicle operation being a driver's operation associated with traveling of a vehicle;
performing vehicle control on the basis of a surrounding environment of the vehicle, the vehicle control being automated driving or driving support of the vehicle;
acquiring a release instruction associated with release of the vehicle control according to the driver's operation on a release operator;
determining whether a type of the vehicle control and a type of the vehicle operation match;
releasing the vehicle control
when the release instruction is acquired and it is determined that the type of the vehicle control and the type of the vehicle operation match; and
continuously performing the vehicle control
when the release instruction is acquired and it is determined that the type of the vehicle control and the type of the vehicle operation do not match.

12. A non-transitory storage medium storing a program causing a computer perform:
detecting a vehicle operation, the vehicle operation being a driver's operation associated with traveling of a vehicle;
performing vehicle control on the basis of a surrounding environment of the vehicle, the vehicle control being automated driving or driving support of the vehicle;
acquiring a release instruction associated with release of the vehicle control according to the driver's operation on a release operator;
determining whether a type of the vehicle control and a type of the vehicle operation match;
releasing the vehicle control
when the release instruction is acquired and it is determined that the type of the vehicle control and the type of the vehicle operation match; and
continuously performing the vehicle control
when the release instruction is acquired and it is determined that the type of the vehicle control and the type of the vehicle operation do not match.
